(19) United States
(12) Patent Application Publication
(10) Pub. No.: US 2005/0265415 A1
(43) Pub. Date: Dec. 1, 2005

(54) Laser diode and method of manufacture

(76) Inventor: John Douglas Lambkin, County Cork (IE)

Correspondence Address: JACOBSON HOLMAN PLLC, 400 SEVENTH STREET N.W., SUITE 600, WASHINGTON, DC, 20004, US

(21) Appl. No.: 11/138,392

(22) Filed: May 27, 2005

Related U.S. Application Data
(60) Provisional application No. 60/575,092, filed on May 28, 2004.

(51) Int. Cl. H01S 3/098

(52) U.S. Cl. 372/43.01

(57) ABSTRACT

VCSEL diode comprises a bottom electrode (10), conducting substrate material (11), a bottom mirror (12) formed by a multilayer distributed Bragg reflector (DBR) of certain conductivity and reflectivity R_{A}, and an active region (13) comprising a plurality of layers some of which are quantum wells. It also comprises a top mirror (14) formed by a multilayer distributed Bragg reflector (DBR) with reflectivity R_{B}<R_{A} and conductivity of a second type. There are a number of layers (15, 18) which through a process of selective oxidation (exposure to a high temperature wet atmosphere) may be selectively converted to oxide layers, therefore producing well defined internal oxide apertures within the top mirror. There is a high-conductivity semiconductor top contact layer (17), a top electrode layer (19) with a centrally located aperture from which light is emitted, and a trench (16) which defines a mesa type VCSEL. The VCSEL comprises at least one oxide suppression layer in the top mirror whose function it is to suppress high order transverse optical modes.

The invention relates to laser diodes and to their manufacture.

The single longitudinal mode operation, low threshold current, and narrow output beam of vertical cavity surface emitting lasers (VCSELs) has ensured that VCSELs are increasingly being deployed in applications such as data transmission in optical networks, optical interconnects, optical storage, sensing, display and laser printing.

For many of these applications it is also highly desirable that the VCSEL not only operate in a single longitudinal mode but that the VCSEL also operate in a fundamental transverse mode. Such VCSELs show increased modulation bandwidth, narrow spectrum, reduced noise, improved coupling efficiency to single mode fibre and whose output beam can be focused to a small ‘well-behaved’ Gaussian spot which is often a requirement for many sensing and display applications.

In both scanning and holographic storage applications it is necessary that the VCSELs operate in a fundamental transverse mode with output powers significantly in excess of 1 mW over a wide temperature range. For holographic storage it is also a requirement that the operating wavelength can be tuned over a wide wavelength range through control of the operating current.

A method of achieving fundamental transverse mode operation for a VCSEL is to implement a selectively oxidised current aperture [1] within the laser structure whereby the mode is confined through strong index confinement between the Al₂O₃ and semiconductor material. To achieve fundamental transverse operation the radius of the current aperture must be kept in the region of only a few microns, and typically for a 850 nm VCSEL the aperture would be in the region of 4 μm. Although the operation of fundamental transverse mode VCSELs has been demonstrated using this method it is nevertheless the case that such VCSELs are prone to a number of significant drawbacks. In particular, small selectively oxidised aperture VCSELs show large differential resistance, which is not conducive with high-speed modulation, and high current densities which may lead to reduced device life-times. The small aperture also limits the maximum output power that can be achieved while still maintaining a fundamental transverse mode. At high drive currents the VCSELs also tend to support multiple transverse modes as thermal lensing effects and gain spatial hole burning begin to predominate.

A technique to enable the use of a large diameter current confinement layer while still maintaining fundamental operation has been put forward [2] based on the use of multiple oxidation layers (mode suppression layers) positioned immediately above the current confinement layer that suppress the oscillation of higher order modes. The function of these mode suppression layers is to increase the scattering losses experienced by the higher order modes and have an aperture larger than the current confinement layer. Although the results shown in Ref [2] show promise the device uses an excessive number of thick mode suppression layers in the vicinity of the active region to achieve sufficient scattering loss to suppress the higher order modes. As the wet selective oxidation process causes an increase in in-built stress within the device, the use of a several thick selective oxidation layers close to the active region is not to be recommended as it is likely to reduce the reliability of the device. The VCSEL embodiments revealed here both avoid this problem and allow an increased level of manufacturing control in relation to achieving the desired diameters of the various oxide apertures.

The invention is therefore directed towards providing a VCSEL which:
can operate in the fundamental transverse mode and/or
can maintain operation in the fundamental transverse mode over a large current range, and/or
can maintain operation in the fundamental transverse mode over an extended temperature range, and/or
can operate with high output optical powers, and/or
can operate at wavelengths from 600-1000 nm
can be fabricated with processes tolerances that allow it to be manufactured in high volume.

### REFERENCES

[1] Huffaker D. L., Deppe D. G., Kumar K. and Rogers T. J., “Native-oxide Defined Ring Contact for Low Threshold Vertical-Cavity Lasers,” Appl. Phys. Lett., vol. 65, pp. 97-99, 1994.

[2] Nishiyama N., Arai M., Shinada S., Suzuki K., Koyama F. and Iga K., “Multi-Oxide Layer Structure for Single-Mode Operation in Vertical-Cavity Surface-Emitting Lasers”, IEEE Photon. Technol. Lett., vol. 12, pp 606-608, 2000.

### SUMMARY OF INVENTION

According to the invention, there is provided a mesa type Vertical Cavity Surface Emitting Laser (VCSEL) diode comprising a bottom contact metalisation, a bottom mirror of one doping type, an active layer region, and a top mirror of another doping type with a ring contact metalisation, wherein the VCSEL comprises at least one suppression layer whose function it is to suppress high order transverse optical modes.

In another embodiment, the suppression layer or layers are of oxide.

In a further embodiment, there are a plurality of suppression layers in the top mirror.

In one embodiment, at least one layer is positioned adjacent to the active region and creates a current aperture of radius greater than or equal to 6 μm.

In another embodiment, the remaining suppression layer(s), are positioned adjacent to the top metal electrode contact and form an emission aperture with a radius which is smaller than the current aperture.

In a further embodiment, the total thickness of the suppression layers is such that the optical path length through these layers differs by ¼ λ as compared to the path length through the VCSEL without the suppression layers.

In one embodiment, the VCSEL comprises a single current confinement selective oxidation layer of thickness of approximately 20 nm and aperture approximately 10 μm and three mode suppression layers each of approximate thickness 30 nm and aperture diameter approximately 8 μm.

In another embodiment, an oxide layer of optical path length of approximately 1/4 λ thickness is deposited and patterned on the surface of the VCSEL such that an annular oxide structure is realised whose function is to suppress the emission of high order transverse optical modes.

In a further embodiment, mode control oxidation layers are used in conjunction with active regions whose cavity lengths are an integer number, n, of the operating wavelength λ and where n is equal to 1 to 10.

In one embodiment, the VCSEL emission is through the substrate.

In another aspect, the invention provides a method of producing a VCSEL comprising the steps of providing a plurality of selective oxidation apertures with differing aperture diameters.

In one embodiment, there is a differential rate of oxidation between two oxidation layers.

In another embodiment, the differential rate is achieved by precise control of the selective oxidation layers' chemical composition.

In a further embodiment, the chemical composition of the two selective oxidation layers is identical and the differential rate of oxidation between the two layers is achieved by the precise control of the thickness of the two layers.

In one embodiment, the chemical composition of the two selective oxidation layers is identical, the differential rate of oxidation between the two layers is achieved by the precise control of the doping of the two layers.

In another embodiment, the chemical composition of the two selective oxidation layers is identical, and the differential rate of oxidation between the two layers is achieved by a two step etch and oxidation process.

### DETAILED DESCRIPTION OF THE INVENTION

The invention will be more clearly understood from the following description of some embodiments thereof, given by way of example only with reference to the accompanying drawings in which:—

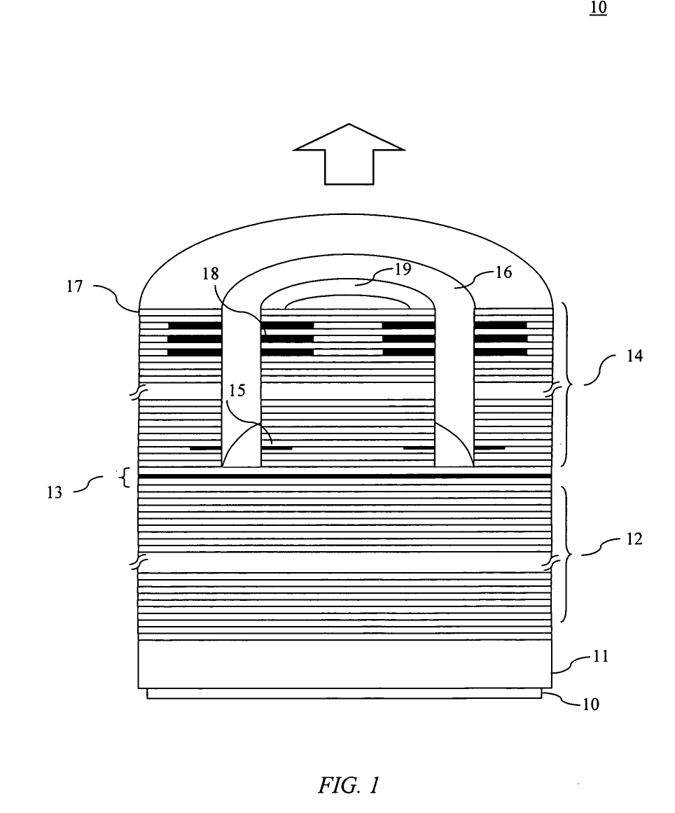

FIG. 1 is a diagrammatic cross-sectional view of a VCSEL diode of the invention;

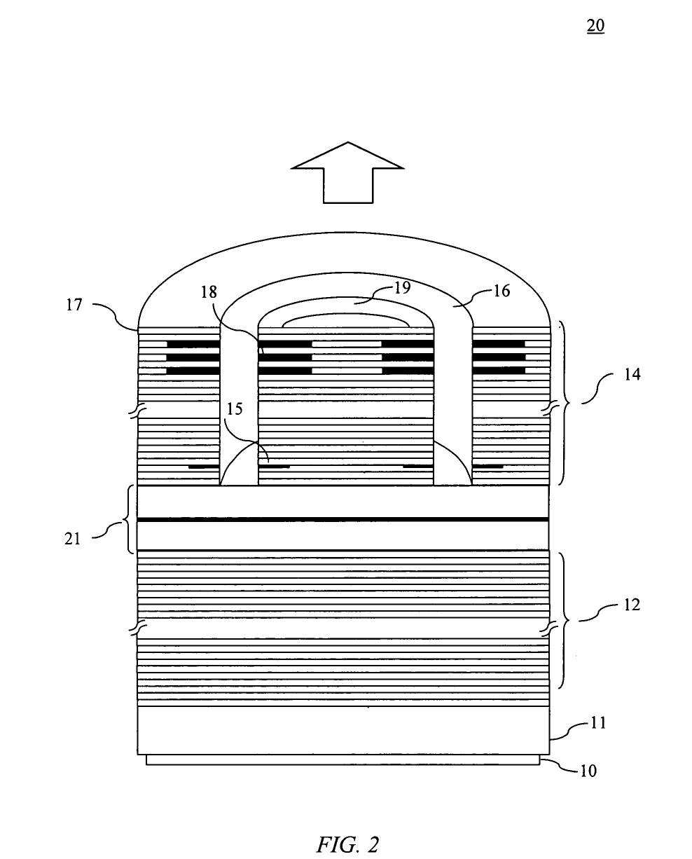

FIG. 2 is diagrammatic cross-sectional view of another embodiment of the VCSEL diode in which mode control selective oxidation layers are used in conjunction with a multiple wavelength active region cavity.

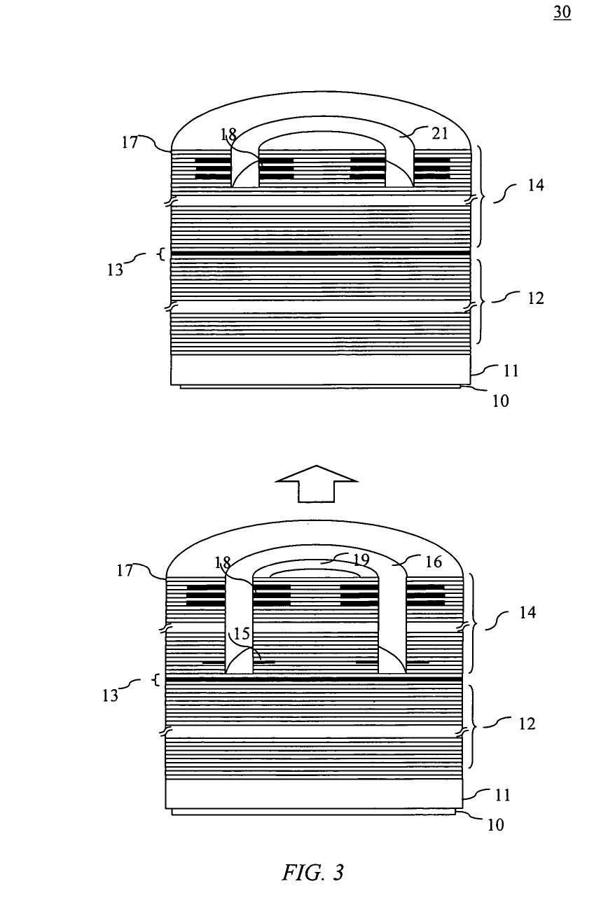

FIG. 3 is a diagrammatic cross-sectional view of the VCSEL diode when fabricated using a multi-step etch and oxidation process; and

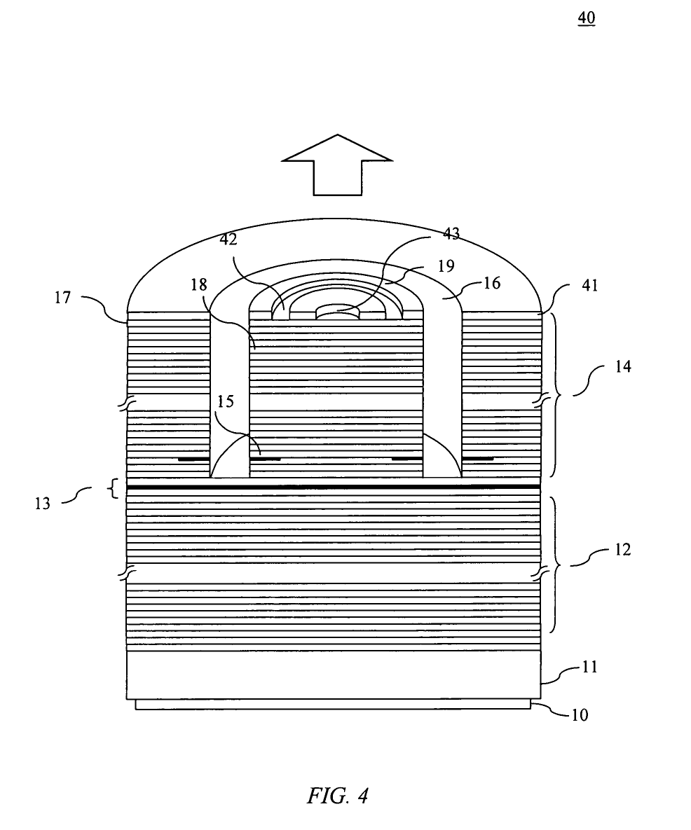

FIG. 4 is diagrammatic cross-sectional view of another embodiment of the VCSEL diode in which an oxide mode control is implemented on the surface of the VCSEL.

Referring to FIG. 1, a general schematic representation of a VCSEL diode 10 of the invention is shown. The VCSEL comprises a bottom electrode 10, conducting substrate material 11, a bottom mirror 12 formed by a multilayer distributed Bragg reflector (DBR) of certain conductivity and reflectivity R_{A}, an active region 13 comprising a plurality of layers some of which are quantum wells, a second mirror 14 (henceforth called the top mirror) formed by a multilayer distributed Bragg reflector (DBR) with reflectivity R_{B}<R_{A} and conductivity of a second type, a number of layers 15, 18 which through a process of selective oxidation (exposure to a high temperature wet atmosphere) may be selectively converted to oxide layers therefore producing well defined internal oxide apertures within the top mirror, a high conductivity semiconductor top contact layer 17, a top electrode layer 19 with a centrally located aperture from which light is emitted, and a trench 16 which defines a mesa type VCSEL.

The substrate 11 is a heavily doped n-type III-V or II-VI semiconductor, such as GaAs, with a thickness of 100-500 μm. The multi-layer bottom DBR is composed of a plurality of pairs (or periods) of semiconductor layers with alternating values of high and low refractive index. The number of pairs is typically in the range of 30-40. The thickness of each layer in the pair is λ/4n, wherein λ is the wavelength of the spontaneous emission of the active region and n the refractive index of the layer. It is important that the refractive index contrast and the total number of mirror pairs is such that the reflectivity of the bottom DBR is greater than that of the output DBR i.e. R_{B}<R_{A}. In the preferred specific embodiment designed for emission at 670 nm the DBR mirror is formed from alternate layers of (Al_{0.5}Ga_{0.5})As and (Al_{0.95}Ga_{0.05})As.

The active region 13 is the region where spontaneous emission of light takes place under the proper bias. In this embodiment the active region 13 comprises a plurality of layers including a single or multiple quantum well structure formed by a narrow band-gap semiconductor confined by wide band-gap semiconductor. Additional wide band-gap spacer layers which may be conductive are placed adjacent to the quantum wells to form the active region which is characterised by high electrical-to-optical conversion efficiency. In a preferred specific embodiment designed for emission in the region of 660 nm the active layer comprises of 3 In_{0.53}Ga_{0.47}P quantum wells of thickness approximately 8 nm with (Al_{0.5}Ga_{0.5})InP barrier material and (Al_{0.7}Ga_{0.3})InP spacer layers.

The bottom and top DBR mirrors surrounding the active region form an optical cavity. The optical cavity length of the VCSEL should be a low integer multiple of λ/2 and thus the thickness of the active region layers is selected on this basis.

Compared to the bottom DBR the top DBR is comprised of a lower number of pairs (typically 20-30) with a lower mirror reflectivity and in this embodiment is of p-type conductivity. This is capped with the highly doped p-type contact layer 17 whose thickness is in the range 10-100 nm. The contact layer is terminated with a metallic electrode with a ring configuration through which the VCSEL light may be emitted.

The top DBR mirror also contains a number of selective oxidation layers, in the embodiment shown in FIG. 3 a single current confinement layer, 15 and three mode suppression layers, 18. The first, 15, is positioned close to the active region 13 and is used to form a current aperture, while the mode suppression layers (18) are placed close to the top metal electrode 19 and is used to control the optical mode.

The diameter of the current confinement aperture 15 is significantly larger than 6 μm and depending upon the exact semiconductor materials used to form the VCSEL 10 may be as large as 20 μm. Such a large aperture would otherwise lead to a multi-spatial moded light output. However, the oxidised mode suppression layers 18 controls the spatial mode of the emission in the diode 10. Unlike the mode suppression layers in Ref [2] the combined optical path length of layers 18 is carefully chosen to have a thickness such that an anti-resonance condition is established. This is accomplished by introducing an approximate ¼ λ phase shift with respect to resonance condition established in the centre of the VCSEL. The apertures of layers 18 are chosen such that high order spatial modes experience a significantly lower modal gain than that experienced by the fundamental mode which propagates unaffected within the aperture of the mode suppression layers 18. The aperture of the mode suppression layers will in general have a smaller diameter than the current confinement aperture. In this fashion the VCSEL of the invention is able to combine the ideal fundamental transverse mode operation with a large current aperture. For the preferred embodiment operating at 660 nm the selectively oxidised current confinement layer will be approximately 20 nm thick and have an aperture diameter of 15 μm. The total thickness of the mode suppression layers will be in the region of 90 nm. In this embodiment three layers are employed each with a thickness of approximately 30 nm and aperture diameter of 8 μm. However in additional embodiments the desired optical path length of the mode suppression layers may be implemented with a greater number of layers but with reduced individual thicknesses.

An additional feature of the embodiment shown in FIG. 1 is that the two types of selective oxidation layers (15, 18) undergo oxidation simultaneously, thus ensuring excellent alignment between the two apertures which is an advantage over surface relief VCSELs where time-consuming lithography and/or costly electron beam lithography techniques are required to achieve the necessary alignment tolerances. In some embodiments it is necessary that the oxide apertures 15 and 18 have different diameters and hence the lateral oxidation rate for the two layers must differ. In one embodiment the differential lateral oxidation rate is achieved using lateral oxidation layers of differing chemical composition. In further embodiments where the chemical composition of the layers is the same the differential lateral oxidation rate is controlled through doping, and in another the differential lateral oxidation rate is controlled through the precise thickness of the layers.

Another VCSEL, 20, is shown in FIG. 2 in which the oxide current confinement layer 15 and the oxide mode control layers 18 are provided together with an extended cavity 21 where the cavity length is a multiple of nλ where n is equal to or greater than 2. The use of the long cavity has the additional effect of increasing the diffraction losses of high order modes and hence in combination with the mode control layer enables the mode control aperture diameter to be increased compared to those VCSELs with a 1 λ cavity.

In an embodiment shown in FIG. 3 the oxidation of the layers is performed separately and necessitate that the mesa etch is undertaken in two stages. In the first stage the mesa etch is used to expose the mode control oxidation layers 18 when it is then oxidised and the side-walls subsequently sealed against further oxidation. In the second stage the mesa etch is continued until the sidewall of the current aperture oxidation layer is exposed and then subsequently oxidised to the desired depth.

In an embodiment shown in FIG. 4 a single mode suppression layer, 41, has been implemented on the surface of the VCSEL by means of e-beam deposition and whose thickness has been chosen to achieve an anti-resonance condition. Layer 41 is patterned by way of a resist lift-off process to define the light emitting aperture, 43, an annulus, 42, in which the Ohmic metal contact, 19, is subsequently deposited and the diameter of the mesa. In this fashion layer 41 is both used as an etch mask to define the mesa and to create in a self-aligned manner the mode suppression layer necessary to promote single fundamental mode operation. In a preferred embodiment of a VCSEL designed to operate at 660 nm the oxide thickness of layer 41 is approximately 90 μm.

The invention is not limited to the embodiments described but may be varied in construction and detail.

1. A mesa type Vertical Cavity Surface Emitting Laser (VCSEL) diode comprising a bottom contact metalisation, a bottom mirror of one doping type, an active layer region, and a top mirror of another doping type with a ring contact metalisation, wherein the VCSEL comprises at least one suppression layer whose function it is to suppress high order transverse optical modes.

2. A VCSEL as claimed in claim 1, wherein the suppression layer or layers are of oxide.

3. A VCSEL as claimed in claim 1, wherein there are a plurality of suppression layers in the top mirror.

4. A VCSEL as claimed in claim 1, wherein there are a plurality of suppression layers in the top mirror; and wherein at least one current confinement layer is positioned adjacent to the active region and creates a current aperture of diameter greater than or equal to 6 μm.

5. A VCSEL as claimed in claim 1, wherein there are a plurality of suppression layers in the top mirror; and wherein at least one current confinement layer is positioned adjacent to the active region and creates a current aperture of diameter greater than or equal to 6 μm; and wherein the remaining suppression layer(s), are positioned adjacent to the top metal electrode contact and form an emission aperture with a radius which is smaller than the current aperture.

6. A VCSEL as claimed in claim 1, wherein the total thickness of the suppression layers is such that the optical path length through these layers differs by ¼ λ as compared to the path length through the VCSEL without the suppression layers.

7. A VCSEL as claimed in claim 1, wherein the VCSEL comprises a single current confinement selective oxidation layer of thickness of approximately 20 nm and aperture approximately 10 μm and three mode suppression layers each of approximate thickness 30 nm and aperture diameter approximately 8 μm.

8. A VCSEL as claimed in claim 1, wherein an oxide layer of optical path length of approximately 1/4 λ thickness is deposited and patterned on the surface of the VCSEL such that an annular oxide structure is realised whose function is to suppress the emission of high order transverse optical modes.

9. A VCSEL as claimed in claim 1, wherein mode control oxidation layers are used in conjunction with active regions whose cavity lengths are an integer number, n, of the operating wavelength λ and where n is equal to 1 to 10.

10. A VCSEL as claimed in claim 1, wherein the VCSEL emission is through the substrate.

11. A method of producing a VCSEL comprising the steps of providing a plurality of selective oxidation apertures with differing aperture diameters.

12. A method as claimed in claim 11, wherein there is a differential rate of oxidation between two oxidation layers.

13. A method as claimed in claim 12, wherein the differential rate is achieved by precise control of the selective oxidation layers' chemical composition.

14. A method as claimed in claim 11, wherein the chemical composition of the two selective oxidation layers is identical and the differential rate of oxidation between the two layers is achieved by the precise control of the thickness of the two layers.

15. A method as claimed in claim 11, wherein the chemical composition of the two selective oxidation layers is identical, the differential rate of oxidation between the two layers is achieved by the precise control of the doping of the two layers.

16. A method as claimed in claim 11, wherein the chemical composition of the two selective oxidation layers is identical, and the differential rate of oxidation between the two layers is achieved by a two step etch and oxidation process.
